(19) United States
(12) Patent Application Publication
(10) Pub. No.: US 2025/0051900 A1
(43) Pub. Date: Feb. 13, 2025

(54) SURFACE TREATMENT METHOD FOR CERAMIC THERMAL SPRAY COATING, AND CERAMIC THERMAL SPRAY COATING

(71) Applicant: TOCALO CO., LTD., Kobe-shi, Hyogo (JP)

(72) Inventors: Akihiro MISHIMA, Kobe-shi, Hyogo (JP); Tomoki FUNATSU, Kobe-shi, Hyogo (JP); Keisuke NICHO, Kobe-shi, Hyogo (JP)

(73) Assignee: TOCALO CO., LTD., Kobe-shi, Hyogo (JP)

(21) Appl. No.: 18/706,873

(22) PCT Filed: Mar. 30, 2023
(86) PCT No.: PCT/JP2023/013114

§ 371 Date: May 2, 2024

(30) Foreign Application Priority Data
Mar. 31, 2022 (JP) 2022-059072

(51) Int. Cl. C23C 4/18; C23C 4/11; C23C 4/134

(52) U.S. Cl. CPC C23C 4/18; C23C 4/11; C23C 4/134

(57) ABSTRACT

To provide a surface treatment method for smoothing the surface of a ceramic thermal spray coating, and a ceramic thermal spray coating subjected to the surface smoothing treatment.

A surface treatment method for a ceramic thermal spray coating, which comprises jetting a slurry containing a liquid having a viscosity at a temperature of 20° C. of 10 mPa/s or lower and a powder medium having a polyhedral structure and having a median diameter (D50) of from 1 to 50 μm with a content of the powder medium of from 1 to 50 vol %, against a surface of a ceramic thermal spray coating, using a compressed gas under a pressure of from 0.01 to 1.0 MPa, to smooth the surface of the ceramic thermal spray coating.

### TECHNICAL FIELD

The present invention relates to a novel surface treatment method to smooth the surface of a ceramic thermal spray coating, and a novel ceramic thermal spray coating subjected to smoothing treatment.

### BACKGROUND ART

As a substrate coating means for the purpose of protecting the surface, imparting functions to the surface, etc., anodic oxidation, plating, physical vapor deposition (PVD), chemical vapor deposition (CVD), thermal spraying and painting may be mentioned. Among them, thermal spraying is capable of forming a coating having a thickness of from several hundred μm to several mm in a short time, and is widely used in view of high productivity in applications in which a thick coating is required.

Further, by thermal spraying, the material to be used can be highly freely selected, and various metals and ceramics can be used for forming a coating. A metal thermal spray coating is used as a sacrificial protection coating to protect a substrate from corrosive environment by forming a metal film which is more basic than the substrate, or to improve abrasion resistance of sliding members. A ceramic thermal spray coating is excellent in heat resistance, abrasion resistance and plasma etching resistance and is thereby widely used for a heat sealing layer to shield a substrate to be thermal-sprayed from heat input, a member susceptible to abrasion by contact with other member, a member susceptible to ablation by exposure to plasma, etc.

However, by thermal spraying, a coating is formed by spraying molten material particles onto an object to be coated, and the roughness of the coating surface greatly depends on the size of the material particles used, and the coating tends to be rough as compared with other coating means. For example, even a coating excellent in abrasion resistance, when brought into contact with other member, may undergo dropping of a fragile structure on the coating surface, abrasion by friction or adhesion to the member in contact with, if the coating has large surface roughness, and the surface roughness or the coefficient of friction of the coating may change. From such reasons, it has been studied to use a thermal spray coating after subjected to surface treatment thereby to smooth the coating.

Patent Document 1 proposes a method such that in a tire testing machine, the surface or a rotating drum imitating a road surface is covered with a steel-based metal thermal spray coating having strength higher than a road surface base material, and the surface is smoothed by mechanical polishing to suppress changes of the roughness and the coefficient of friction by adhesion of the tire, thereby to obtain stable test results.

Further, Patent Document 2 proposes a surface treatment method of polishing the surface of a metal thermal spray coating formed on the surface of a building of e.g. concrete, by jetting such as liquid honing or dry blasting to obtain a glossy finished surface equal to a metal surface.

### PRIOR ART DOCUMENTS

### Patent Documents

Patent Document 1: JP-A-2013-36750
Patent Document 2: JP-A-H04-083862

### DISCLOSURE OF INVENTION

### Technical Problem

In the case of mechanical polishing to smooth the surface of a thermal spray coating as disclosed in Patent Document 1, a locally heavy load is applied since a processing tool is directly pressed against the coating surface for grinding. The thermal spray coating will be damaged if the substrate is significantly deformed by a load, and thus the object to be treated is requited to have a structure and a strength insusceptible to deformation by a load. Such tends to be more problematic in ceramic thermal spray coatings which are fragile and are likely to be broken as compared with metal thermal spray coatings.

Further, in mechanical polishing, in a case where the object to be treated has a curved surface or a three-dimensional structure constituted by two or more faces, it is necessary to use a machining center. The larger the dimensions of the object to be treated, the larger the dimensions of the machine accordingly, and the area which can be treated is restricted by interference between the machine and the object to be treated, and the cost for equipment introduction increases. Further, in mechanical polishing, it is required to bring the tip of a processing tool into contact with the surface to be treated of the object to be treated, and it is necessary to feed detailed information regarding dimensions of the object so as to run the processing tool along the whole region to be treated, into the processing machine. However, it is difficult to measure the dimensions and shape of the object to be treated having a complicated curved surface, and many practical problems remain in smoothing by mechanical polishing.

On the other hand, jetting (blasting) such as liquid honing or dry blasting, as a means of smoothing the surface of the thermal spray coating as disclosed in Patent Document 2, is a method of spraying a powder medium such as abrasive grains as it is or as a mixture with a liquid, over an object to be treated by compressed air to grind the surface, or a method of imparting peening effect by an impact by collision of the medium. A jetting gun is small as compared with the machining center, and is less likely to interfere with the object to be treated. Further, jetting effects are obtained even the distance from the jetting gun to the surface to be treated changes, and thus jetting can easily be made to follow even a surface to be treated having a complicated three-dimensional shape. From such advantages, jetting can be employed even for large-sized objects and objects having a complicate shape, as compared with smoothing treatment by a machining center.

However, in Patent Document 2, the thermal spray coating is formed of a metal material, and ceramic thermal spray coatings have not been studied. According to studies by the present inventors, it was found as follows. That is when jetting is conducted on a ceramic thermal spray coating, the ceramic coating is electrified or generates heat and is destroyed by the friction at the time of collision of the medium and the piezoelectric effect.

In addition, when a rigid medium such as abrasive grains is crashed against the ceramic surface which is a fragile material, medium particles are stuck into the treated surface and are likely to remain and thereby cause surface pollution. Further, in a case where the crashed medium particles have no effect to grind the ceramic thermal spray coating surface and are rebounded on the ceramic thermal spray coating surface, the treated surface of the ceramic thermal spray coating is crushed and forms a fragile structure, and the bond at the interface between spray particles is destroyed and the spray particles drop off, whereby a nascent surface, which has not been ground, is exposed on the outermost surface.

The above problem caused by jetting over the ceramic thermal spray coating should be avoided in the field of e.g. a semiconductor production devices, of which the thermal spray coating surface is required to have high cleanness and homogeneity. Further, in order to stably jet the medium, it is necessary to use a medium having favorable flowability. The smaller the grain size of the medium, the lower the flowability, and thus a medium which can be used for jetting is limited to one having a relatively large grain size. A medium having a large grain size has small smoothing effects and high impact on the object to be treated and induces crush of the surface, and thus development of surface treatment with stable use of a medium having a smaller particle size has been required.

Under these circumstances, the object of the present invention is to provide a novel surface treatment method for smoothing the surface of a ceramic thermal spray coating, and a novel ceramic thermal spray coating having smoothing treatment applied.

### Solution to Problem

The present invention has been made to achieve the above object, and provides the following.

(1) A surface treatment method for a ceramic thermal spray coating, which comprises jetting a slurry containing a liquid having a viscosity at a temperature of 20° C. of 10 mPa/s or lower and a powder medium having a polyhedral structure and having a median diameter (D50) of from 1 to 50 μm with a content of the powder medium of from 1 to 50 vol %, against a surface of a ceramic thermal spray coating, using a compressed gas under a pressure of from 0.01 to 1.0 MPa, to smooth the surface of the ceramic thermal spray coating.
(2) The surface treatment method according to (1), wherein the ceramic thermal spray coating is formed of a rare earth oxide, a rare earth oxyfluoride, a rare earth fluoride, alumina (Al₂O₃), YAG(Y₃Al₅O₁₂) or YAP(YAlO₃).
(3) The surface treatment method according to (1) or (2), wherein the powder medium is formed of tetrahedral or more polyhedral particles with an angle formed by faces of from 10 to 135°.
(4) The surface treatment method according to any one of (1) to (3), wherein the powder medium is formed of glass containing silicon oxide (SiO₂) as the main component, alumina (Al₂O₃), silicon carbide (SiC), boron carbide (B₄C), silicon nitride (Si₃N₄), zirconia (ZrO₂), carbon steel or stainless steel.
(5) The surface treatment method according to any one of (1) to (4), wherein the liquid is water or a C₂₋₄ alcohol.
(6) The surface treatment method according to any one of (1) to (5), wherein the compressed gas is air, nitrogen, carbon dioxide or argon.
(7) The surface treatment method according to any one of (1) to (6), wherein the surface of the ceramic thermal spray coating is smoothed to an arithmetic mean roughness Ra of 3.0 μm or less and a skewness Rsk of 0 or less.
(8) The surface treatment method according to any one of (1) to (7), wherein a plurality of grinding marks having a width of from 0.01 to 5 μm and a length of from 0.01 to 10 μm are formed on the surface of the ceramic thermal spray coating.
(9) The surface treatment method according to any one of (1) to (8), wherein the surface of the ceramic thermal spray coating is smoothed so that the nascent surface-occupied area ratio calculated by the following formula (1) is 10% or lower:

nascent surface-occupied area ratio (%)=(area of nascent surface/area of treated surface)×100 (1)

(10) The surface treatment method according to any one of (1) to (9), wherein the surface of the ceramic thermal spray coating is smoothed so that the grinding mark-occupied area ratio calculated by the following formula (2) is 50% or higher:

grinding mark-occupied area ratio (%)={(area of grinding mark region−area of voids−area of nascent surface)/area of treated surface}×100 (2)

(11) The surface treatment method according to any one of (1) to (10), wherein the ceramic thermal spray coating is a thermal spray coating on an inner wall member of a plasma etching device for semiconductor production.
(12) The surface treatment method according to any one of (1) to (10), wherein the ceramic thermal spray coating is a thermal spray coating on a sliding member selected from a bearing, a piston and a cylinder.
(13) A ceramic thermal spray coating subjected to surface smoothing treatment, which has a treated surface having an arithmetic mean roughness Ra of 3 μm or less and a skewness Rsk of 0 or less.
(14) The ceramic thermal spray coating according to (13), which has a nascent surface-occupied area ratio calculated by the following formula (1) of 10% or less:

nascent surface-occupied area ratio (%)=(area of nascent surface/area of treated surface)×100 (1)

(15) The ceramic thermal spray coating according to (13) or (14), which has a grinding mark-occupied area ratio calculated by the following formula (2) of 50% or higher:

grinding mark-occupied area ratio (%)={(area of grinding mark region−area of voids−area of nascent surface)/area of treated surface}×100 (2)

### Advantageous Effects of Invention

According to the present invention, a novel surface treatment method capable of smoothing a ceramic thermal spray coating, and a ceramic thermal spray coating subjected to surface smoothing treatment, are provided. Particularly, according to the present invention, provided is a novel ceramic thermal spray coating having less fragile crushed layer which is likely to drop off after the smoothing treatment, useful for e.g. an inner wall member of a plasma etching device for semiconductor production which is required to have high cleanness.

### BRIEF DESCRIPTION OF DRAWINGS

FIG. 1 is an SEM image of the surface of the ceramic thermal spray coating before surface treatment of the present invention.

FIG. 2a is an SEM image (×1000 magnifications) of the surface of the ceramic thermal spray coating obtained by the surface treatment method in Example of the present invention, particularly illustrating a nascent surface b and voids c.

FIG. 2b is an SEM image (×1000 magnifications) of the surface of the ceramic thermal spray coating obtained by the surface treatment method in Example of the present invention, particularly illustrating grinding marks in a 10 μm×10 μm block.

FIG. 2c is an SEM image (×5000 magnifications) of the surface of the ceramic thermal spray coating obtained by the surface treatment method in Example of the present invention.

FIG. 2d is an SEM image of the surface of the ceramic thermal spray coating obtained by the surface treatment method in Comparative Example 1.

FIG. 2e is an SEM image of the surface of the ceramic thermal spray coating obtained by the surface treatment method in Comparative Example 2.

FIG. 3a is an SEM image of an adhesive surface of an adhesive tape which has been bonded to the surface of the ceramic thermal spray coating obtained by the surface treatment method in Example of the present invention and then peeled.

FIG. 3b is an SEM image of an adhesive surface of an adhesive tape which has been bonded to the surface of the ceramic thermal spray coating obtained by the surface treatment method in Comparative Example 1 of the present invention and then peeled.

FIG. 3c is an SEM image of an adhesive surface of an adhesive tape which has been bonded to the surface of the ceramic thermal spray coating obtained by the surface treatment method in Comparative Example 2 of the present invention and then peeled.

### DESCRIPTION OF EMBODIMENTS

Now, embodiments of the present invention will be described in detail below. In this specification, “X to Y” used to show the range of numerical values is used to include the lower limit value (X) and the upper limit value (Y), and when the units of the upper limit value and the lower limit value are the same, description of the unit of the lower limit value may sometimes be omitted.

### [Ceramic Thermal Spray Coating]

The material of the ceramic thermal spray coating to be subjected to the surface treatment of the present invention includes an inorganic solid material composed mainly of a non-noble metal, which is a ceramic such as an oxide, a fluoride, a silicide, a nitride, a carbide, a boride and carbon.

For example, zirconia (ZrO₂), silicon dioxide (SiO₂), alumina (Al₂O₃), yttria (Y₂O₃), calcium fluoride (CaF₂), yttrium fluoride (YF₃), tungsten silicide (WSi₂), tungsten carbide (WC) and zirconium boride (ZrB₂) may be mentioned. Further, a composite oxide containing two or more types of anions or cations, a composite fluoride, an oxyfluoride, and a carbonitride may also be mentioned. As examples, YAG(Y₃Al₅O₁₂), zirconium potassium fluoride (K₂ZrF₆), yttrium oxyfluoride (YOF), soda glass containing silicon oxide as the main component, and borosilicate glass may be mentioned.

The material of the ceramic thermal spray coating of the present invention may, for example, be a rare earth oxide, a rare earth oxyfluoride, a rare earth fluoride, alumina (Al₂O₃), YAG(Y₃Al₅O₁₂) or YAP (YAlO₃). Among them, yttria (Y₂O₃), yttrium oxyfluoride (YOF) and yttrium fluoride (YF₃) are preferred. This is because the thermal spray coating formed of such a material is suitable for e.g. a semiconductor production device of which the surface is required to have not only high smoothness but also high cleanness and homogeneity.

As the material of the substrate on which the ceramic thermal spray coating is to be formed, a known one such as an aluminum alloy, a stainless steel alloy, quartz or an alumina sintered product may be used. Further, as a method of forming the ceramic thermal spray coating, a known method such as atmospheric plasma thermal spraying or vacuum plasma thermal spraying may be employed.

FIG. 1 is an SEM image of the surface of the ceramic thermal spray coating before the surface treatment of the present invention. As shown in FIG. 1, the surface of the ceramic thermal spray coating before the surface treatment has an irregular rough shape such that ceramic particles molten in the thermal spraying process have collided against the substrate and have been flattened or have flown off as droplets.

### [Surface Treatment Method]

In the surface treatment method of the present invention, the surface of the above described ceramic thermal spray coating is blasted (jetted) with a slurry containing a powder medium having a polyhedral structure using a compressed gas such as compressed air. The slurry, the blasting device, and the blasting conditions employed when the surface treatment is conducted, will be described below.

### (Slurry)

The slurry used in the surface treatment method of the present invention is formed in such a form that powder medium particles are suspended in a liquid. The content (concentration) of the powder medium in the slurry is, as represented by volume percentage, preferably from 1 to 50 vol %. If the content of the powder medium is less than 1 vol %, the grinding amount tends to be small, whereby the time required for the surface treatment tends to be long, and such is not efficient. On the other hand, if the content of the powder medium is higher than 50 vol %, the powder medium particles will not be dispersed in the liquid but will settle, and no favorable slurry will be obtained. The content of the powder medium is more preferably from 5 to 45 vol %, further preferably from 10 to 40 vol %.

The liquid constituting the slurry is preferably one having a viscosity of 10 mPa/s or less at a temperature of 20° C. If the viscosity is higher than 10 mPa/s, jetting of the liquid tends to be difficult. The viscosity of the liquid is more preferably 1 to 5 mPa/s, particularly preferably from 1 to 3 mPa/s. The liquid is preferably water or a hydrophilic solvent. The hydrophilic solvent is preferably a C₂₋₄ alcohol such as ethyl alcohol or isopropyl alcohol.

The powder medium particles constituting the slurry have a polyhedral structure. In the present invention, the polyhedral medium particle mean a body constituted by linear edges connecting vertices and faces surrounded by the edges. The polyhedron has, for example, 4 faces or more, preferably 5 faces or more, and for example, 20 faces or less, preferably 15 faces or less. The polyhedron may be an irregular polyhedron or may be a regular polyhedron (such as regular hexahedron (cube) or regular octahedron). Further, the powder medium may be a mixture of two or more irregular polyhedral particles and/or regular polyhedral particles.

Particularly, the polyhedron has an angle formed by faces of preferably from 10 to 135°, more preferably from 10 to 90°, particularly preferably an acute angle of from 30 to 80°. By having an angle within the above range, when the polyhedral particles collide against the surface of the thermal spray coating by blasting (jetting), grinding marks can readily be formed on the surface of the thermal spray coating.

The polyhedron in the present invention does not include a sphere and an ellipse (a rugby ball) having no vertex (corner). If a powder medium in the form of a sphere or an ellipse (rugby ball) having no vertex (corner) is used, the medium particles which had collided against the surface to be treated of the ceramic thermal spray coating do not cut the ceramic thermal spray coating surface in and rebound, and thus the kinetic energy at the time of collision functions as a blow, not as grinding, on the surface to be treated. As a result, the ceramic thermal spray coating surface is not ground, but by the blow, formation of a fragile crushed layer and dropping of spray particles due to destruction at the boundary between the spray particles will occur.

In the surface treatment method of the present invention, which uses the polyhedral powder medium, the tips of the medium particles, such as the vertices of the polyhedral particles, which had collided against the surface of the ceramic thermal spray coating, cut in and grind the surface of the thermal spray coating to be treated, whereby the spray coating can be smoothed while crushing of the thermal spray coating surface and dropping of spray particles due to destruction at the boundary between the spray particles are suppressed.

The particle size of the powder medium is, as the median diameter D50, preferably from 1 to 50 μm. If the particle size is less than 1 μm, the grinding amount tends to be small, and the time required for the surface treatment tends to be long, such being not efficient. On the other hand, if the particle size is larger than 50 μm, the grinding amount tends to be large, and the surface can hardly be smoothed. The particle size is more preferably from 5 to 40 μm, particularly preferably from 5 to 30 μm. By using the powder medium having a particle size within such a range, the effect of the blow on the ceramic thermal spray coating tends to be small, and crushing of the coating surface and dropping of spray particles due to destruction at the boundary between the spray particles can be more suppressed. The median diameter D50 is a particle size at 50% cumulative height as specified by JIS R6002-1998.

The material of the powder medium may be either a ceramic or a metal. The ceramic material may, for example, be glass containing silicon oxide (SiO₂) as the main component, alumina (Al₂O₃), silicon carbide (SiC), boron carbide (B₄C), silicon nitride (Si₃N₄) or zirconia (ZrO₂). Particularly, alumina (Al₂O₃) or silicon carbide (SiC) is preferred. The metal material may, for example, be carbon steel or stainless steel. Particularly, stainless steel (such as SUS304 or SUS430) is preferred.

The polyhedral powder medium used in the present invention may be obtained by crushing or forming an aggregate to be the powder medium, or may be commercially available. The powder medium may, for example, be alumina (manufactured by WANAMI, Co., Ltd., tradename: White Alundom), silicon carbide (manufactured by Fuji Manufacturing Co., Ltd., tradename: Fuji Random C) or alumina zirconia (manufactured by SAINT-GOBAIN, tradename: NorZon NV).

In the surface treatment of the present invention, a medium with a small particle size having poor flowability so that it cannot be stably jetted by dry blasting, is formed into a slurry, whereby the medium can be sprayed over the surface of the ceramic thermal spray coating, and the thermal spray coating can be smoothed while heat generation and electrification of the object to be treated are suppressed.

In addition, by using the slurry containing the polyhedral powder medium, the medium exercises strong grinding effects on the coating surface, and the coating surface can be smoothed by grinding while crushing of the coating surface and dropping of spray particles due to destroy at the boundary between the spray particles, by the effects of the below, are prevented. As a result, the surface of the ceramic thermal spray coating smoothed by using the slurry containing the polyhedral powder medium according to the present invention, contains substantially no untreated portion which has not been ground caused by dropping of the spray particles and fragile crushed layer which is likely to drop.

### (Blasting Device, Conditions)

Jetting of the slurry containing the powder medium over the surface of the ceramic thermal spray coating may be conducted by compressed gas, that is by a known wet blasting device of jetting both a compressed gas and a slurry.

As the compressed gas, air, nitrogen, carbon dioxide, argon, and the like may be used. Particularly, air, which is available at low cost and which is inert, is preferred.

The slurry containing the powder medium is jetted over the ceramic thermal spray coating surface using a compressed gas under a jet pressure of preferably from 0.01 to 1.0 MPa (gauge pressure) to conduct blasting. If the jet pressure is less than 0.01 MPa, the grinding amount tends to be small, whereby the time required for the surface treatment tends to be long, and such is not efficient. On the other hand, if the jet pressure is higher than 1.0 MPa, the grinding amount tends to be large, and the surface can hardly be smoothed. The jet pressure is more preferably from 0.1 to 0.5 MPa.

### [Surface of Surface-Treated Ceramic Thermal Spray Coating]

The surface of the ceramic thermal spray coating surface-treated in the present invention preferably has an arithmetic mean roughness Ra of preferably 3.0 μm or less, more preferably from 0.1 to 2.5 μm, further preferably from 0.1 to 2.0 μm. When the arithmetic mean roughness Ra is 3.0 μm or less, the surface tends to have small irregularities, however if it is larger than 3.0 μm, the surface tends to be a rough surface having large irregularities, and the treated surface tends to be abrade by friction in the use environment. The smaller the arithmetic mean roughness Ra is, the less the surface tends to be abraded and the more suitable.

Further, the surface of the ceramic thermal spray coating surface-treated in the present invention has a skewness Rsk of preferably 0 or less, more preferably −1.0 or more and −0.01 or less. If the skewness Rsk is more than 0, the surface tends to be dominated by convex sharp-edged fine peaks and is likely to be abraded. On the other hand, when the skewness Rsk is less than 0, the surface tends to be dominated by fine valleys. In other words, the surface tends to have less fine peaks and is less likely to be abraded, such being preferred. In the present invention, the arithmetic mean roughness Ra is measured in accordance with JIS B0601, 1994. The skewness Rsk is also measured in accordance with JIS B0601, 1994.

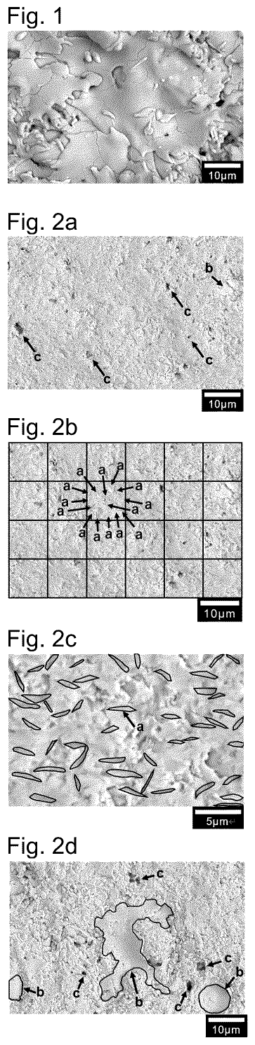

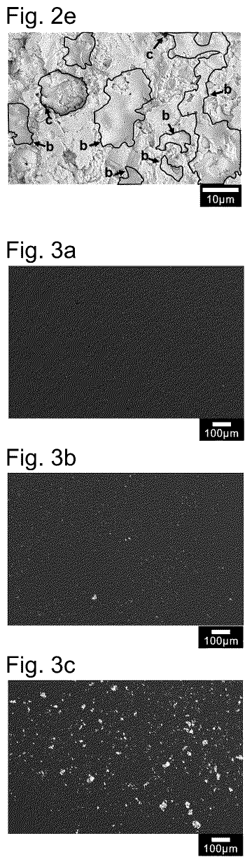

FIG. 2a and FIG. 2b are both SEM images of the surface of the ceramic thermal spray coating after subjected to the surface treatment method in Example of the present invention with 1000 magnifications, and FIG. 2c is an SEM image with 5000 magnifications.

As shown in FIG. 2a. the surface of the ceramic thermal spray coating subjected to the surface treatment method of the present invention has countless grinding marks which are not shown, a nascent surface indicated by arrow b and voids indicated by arrows c.

Arrows a in FIG. 2b and region a in FIG. 2c illustrate a grinding mark. By the blasting of the present invention, the treated region of the ceramic thermal spray coating surface is ground by the powder medium to form grinding marks having a width of from 0.01 to 5 μm and a length of from 0.01 to 10 μm on the surface (treated surface) of the surface-treated ceramic thermal spray coating. By the surface of the ceramic thermal spray coating having countless such grinding marks, uniform surface properties will be obtained.

Further, FIG. 2b illustrates 10 μm×10 μm blocks, which are used to specify the after-described grinding mark region. In FIG. 2b, only grinding marks present in a certain block are indicated by arrows a, and grinding marks in other blocks are not indicated, but which does not indicate absence of grinding marks in the other blocks.

The ceramic thermal spray coating by the surface treatment of the present invention is characterized in that the nascent surface formed on the treated surface is small. The nascent surface means, as indicated by arrow b in FIG. 2a and regions b in FIG. 2d and FIG. 2e, an exposed surface which is formed by destruction at the boundary between spray particles and resulting dropping of the spray particles from the surface at the time of the surface treatment.

The nascent surface-occupied area ratio is preferably low, and in the present invention, the nascent surface-occupied area ratio can be made lower than 10%, whereby the surface non-uniform in the roughness can be made sufficiently small. In the present invention, the nascent surface-occupied area ratio can be made 5% or lower, further, 1% or lower. When the nascent surface-occupied area ratio is within such a range, the surface non-uniform in the roughness can be made very small.

In the present invention, the nascent surface-occupied area ratio (%) is obtained in accordance with the following formula (1):

Nascent surface-occupied area ratio (%)=(area of nascent surface/area of treated surface)×100 (1)

In the above formula (1), the nascent surface-occupied area ratio is obtained by observing the treated surface in an SEM image with 1,000 magnifications and specifying the position of the nascent surface, and calculating the ratio of the area occupied by the nascent surface in the observed area by an image analysis software.

Further, the surface of the ceramic thermal spray coating surface-treated by the present invention, has a plurality of grinding marks formed by collision of the polyhedral medium. By collision of the polyhedral medium, formation of an exposed nascent surface by dropping of spray particles forming the thermal spray coating on the surface of the ceramic thermal spray coating can be suppressed.

In the present invention, a grinding mark, as indicated by arrows a in FIG. 2b and region a in FIG. 2c, a dent having a short side of from 0.01 to 5 μm, a long side of from 0.01 to 10 μm and an aspect ratio of the long side to the short side of 1.5 or higher, observed on the treated surface of the thermal spray coating with an SEM. The grinding mark-occupied area ratio (%) is calculated in accordance with the following formula (2).

Grinding mark-occupied area ratio (%)={(total area of grinding mark region−area of voids−area of nascent surface)/area of treated surface}×100 (2)

In the above formula (2), the total area of the grinding mark region means as follows. As shown in FIG. 2b, the treated surface of the thermal spray coating, in an SEM image with 1,000 magnifications, is divided into 10 μm×10 μm blocks, and the total area of blocks including 5 or more grinding marks (the respective blocks will be referred to as “grinding mark region”) is taken as the total area of the grinding mark region. The voids are portions formed in production of the thermal spray coating, which remain after the surface treatment, and correspond to black spots observed with an SEM, as indicated by arrows c in FIG. 2a, FIG. 2d and FIG. 2e. The area of the voids can be calculated by an image analysis software.

The area of the nascent surface in the formula (2) is as described above, and the nascent surface means the exposed surface formed by destruction at the boundary between spray particles and resulting dropping of the spray particles at the time of the surface treatment, and corresponds to portions indicated by arrow b in FIG. 2a and regions b in FIG. 2d and FIG. 2e, as observed with an SEM. The area of the nascent surface can be calculated by an image analysis software.

In the present invention, the grinding mark-occupied area ratio calculated from the formula (2) is preferably 50% or higher, more preferably 80% or higher, further preferably 90% or higher. When the grinding mark-occupied area ratio is within the above range, a surface more uniform in the roughness will be formed in a wide range.

### EXAMPLES

Now, the present invention will be described in further detail with reference to Example of the present invention, however, the present invention is by no means restricted to such specific Example.

In the following Example and Comparative Example, the state of the ceramic thermal spray coating formed on a substrate (A5052: aluminum alloy), before treatment, was as follows.
thermal spray coating material: Y₂O₃
thermal spraying coating thickness: about 0.2 mm
arithmetic mean roughness Ra of thermal spray coating surface: 3.59 μm
skewness Rsk of thermal spray coating surface: 0.15

To the above ceramic thermal spray coating, surface treatment using the polyhedral medium of the present invention (Example), wet blasting treatment using spherical medium (Comparative Example 1) and surface treatment by dry blasting (Comparative Example 2) were conducted.

The powder medium used in Example was alumina polyhedral particles having a grain size with a median diameter D50 of 21.5 μm (manufactured by WANAMI, Co., Ltd., tradename: White Alundom #600 (mixture of tetrahedral to undecahedral particles, angle formed by faces: 10 to 135°. The powder medium used in Comparative Example 1 was alumina spherical particles having a grain size with a median diameter D50 of 22.1 μm (manufactured by Denka Company Limited, DAW-20), and the powder medium used in Comparative Example 2 was alumina spherical particles having a grain size with a median diameter D50 of 71.5 μm (manufactured by Denka Company Limited, DAW-70).

The surface treatment conditions in Example and Comparative Examples are shown in the following Table 1. The film reduction in Table 1 is the reduction of the thickness of the thermal spray coating, as obtained by measuring the thicknesses of the test specimen before and after the surface treatment by a micrometer. The jet pressure value is a value by gauge pressure.

TABLE 1

| | | | Comparative | | Comparative | |
|---|---|---|---|---|---|---|
| | Example | | Example 1 | | Example 2 | |
| Jet device | Manufactured | | Manufactured | | Manufactured by | |
| | by OneBox; | | by OneBox; | | Fuji Manufacturing | |
| | REBORN | | REBORN | | Co., Ltd.; SGD-0- | |
| | | | | | 401 | |
| Jet method | Wet blasting | | Wet blasting | | Dry blasting (by | |
| | | | | | gravity) | |
| Jet pressure | 0.35 | MPa | 0.35 | MPa | 0.35 | MPa |
| Material of | Alumina | | Alumina | | Alumina | |
| medium | | | | | | |
| Shape of medium | Tetrahedral to | | Spherical | | Spherical | |
| | undecahedral | | | | | |
| Median diameter | 21.5 | μm | 22.1 | μm | 71.5 | μm |
| Liquid | Pure water | | Pure water | | — | |
| Viscosity of | 1.0 | | 1.0 | | — | |
| liquid | | | | | | |
| Slurry | 15 | vol % | 15 | vol % | — | |
| concentration | | | | | | |
| Nozzle | 7 | mm | 7 | mm | 7 | mm |
| diameter (φ) | | | | | | |
| Jet distance | 100 | mm | 100 | mm | 100 | mm |
| Film reduction | 57 | μm | 62 | μm | 55 | μm |

To evaluate the surface structure, the roughness and the amount of the fragile layer of the thermal spray coating after each of the surface treatments, the arithmetic mean roughness Ra and the skewness Rsk on the surface of the thermal spray coating subjected to the surface treatment, were measured by a stylus profilometer, and the results are shown in Table 2.

To conduct the above test, the test specimen, after the surface treatment, was subjected to ultrasonic cleaning in pure water and dried in a constant temperature chamber kept at 60° C.

TABLE 2

| | Before | | | |
|---|---|---|---|---|
| | surface | | Comparative | Comparative |
| | treatment | Example | Example 1 | Example 2 |
| Arithmetic mean | 3.59 μm | 1.83 μm | 2.28 μm | 1.90 μm |
| roughness Ra | | | | |
| Skewness Rsk | 0.15 | −0.203 | −0.16 | −0.37 |

As shown in Table 2, after the surface treatment of the thermal spray coating in each of Example, Comparative Example 1 and Comparative Example 2, the arithmetic roughness Ra and the skewness Rsk are smaller than those before the surface treatment, and thus it is found that the surface is smoothed.

The surface of the thermal spray coating subjected to the surface treatment was observed with a scanning electron microscope (manufactured by JEOL Ltd., 6060LA). Surface SEM images in Example, Comparative Example 1 and Comparative Example 2 are shown in FIG. 2a, FIG. 2b and FIG. 2c, in FIG. 2d and in FIG. 2e, respectively. In FIG. 2d and FIG. 2e, examples of the nascent surface formed by dropping of the spray particles are shown as regions b. Further, in the following Table 3, the area ratios occupied by the nascent surface, which has not been ground, formed by dropping of the spray particles in FIG. 2a (Example), FIG. 2d (Comparative Example 1) and FIG. 2e (Comparative Example 2), are shown.

The nascent surface-occupied area ratio (%) was obtained by specifying the area of the nascent surface in an image with 1,000 magnifications, and calculating the ratio (%) in the image with 1,000 magnifications.

As shown in FIG. 2d and FIG. 2e, in Comparative Example 1 and Comparative Example 2, even though the film reduction was at a level of 60 μm, nascent surfaces, which are splat flat smooth spray particle surfaces (FIG. 1), observed on the thermal spray coating surface before the treatment, newly exposed by dropping of the particles, are observed dispersively. Whereas in Example, as shown in FIG. 2a, smoothing treatment could be conducted while dropping of the spray particles was suppressed, and the nascent surface-occupied area ratio is so low as 1% or lower.

In FIG. 2c, an example of the grinding mark formed by collision of the polyhedral medium in Example is shown by region a. The grinding mark in the region a has a length of about 2 μm and a width of about 0.8 μm, and as shown in FIG. 2a and FIG. 2b, countless grinding marks with various sizes are shown on almost the whole treated surface. In the following Table 3, the grinding mark-occupied area ratio in the region on which the grinding marks are formed, in FIG. 2b (Example), FIG. 2d (Comparative Example 1) and FIG. 2e (Comparative Example 2), is shown.

The grinding mark-occupied area ratio (%) is obtained, from the above formula (2), as follows. That is, in the image with 1,000 magnifications, the area of regions having 5 or more grinding marks in a 10 μm×10 μm block (the area of grinding mark regions), the area of voids in the grinding mark regions, and the area of the nascent surface in the grinding mark regions, are specified, the area obtained by subtracting the area of the void and the area of the nascent surface from the total area of the grinding mark regions was obtained, and the proportion of the obtained area in the image with 1,000 magnifications was calculated.

TABLE 3

| | | Comparative | Comparative |
|---|---|---|---|
| | Example | Example 1 | Example 2 |
| Void-occupied area ratio | 1.9% | 2.4% | 1.4% |
| Nascent area-occupied area ratio | 0.7% | 15.2% | 34.7% |
| Grinding mark-occupied area | 97.4% | 0% | 0% |
| ratio | | | |

As evident from Table 3, almost the whole surface in Example is occupied by regions having grinding marks formed. Whereas on the surface in each of Comparative Example 1 and Comparative Example 2, no grinding mark is observed, and the surface is constituted by the spray particle surface exposed by dropping of the spray particles and the crushed surface formed by collision of the medium.

To the surface of the surface-treated thermal spray coating, a polyimide tape (manufactured by TERAOKA SEISAKUSHO CO., LTD, double-coated adhesive Kapton film tape 760H #25) was bonded under a pressure of 0.3 MPa and peeled, and the adhesive surface of the tape was observed with a scanning electron microscope (manufactured by JEOL Ltd., 6060LA) to evaluate the amount of the fragile crushed layer of the coating surface, transferred to the tape.

SEM images of the adhesive surface of the tape after the transfer test in Example, Comparative Example 1 and Comparative Example 2 are shown in FIG. 3a, FIG. 3b and FIG. 3c, respectively. The transfer ratios of the coating fragments transferred, illustrated by white spots in FIG. 3a, FIG. 3b and FIG. 3c, are shown in Table 4.

The transfer ratio of the coating fragments was obtained as follows. A 1200 μm×700 μm observation range in an SEM image was analyzed by an image analysis software (manufactured by MITANI CORPORATION, WinROOF2018) to specify the area occupied by the transferred coating fragments in the image, and the proportion (%) in the observation range was calculated.

In Comparative Example 1 and Comparative Example 2, the transfer ratio is high, and it is found that a large part of the surface has a fragile crushed layer. In Example, the transfer ratio is remarkably low, and it is found that the smoothing treatment could be conducted while formation of a fragile crushed layer was suppressed.

TABLE 4

| | | Comparative | Comparative |
|---|---|---|---|
| | Example | Example 1 | Example 2 |
| Transfer ratio | 0.10% | 0.78% | 3.11% |

The same operation as in the above Example was conducted except that silicon carbide polyhedral particles (manufactured by Fuji Manufacturing Co., Ltd., tradename: Fuji Random C#400) were used as the powder medium instead of the alumina polyhedral particles (manufactured by WANAMI, Co., Ltd., tradename: White Alundom #600), and as a result, substantially the same results were obtained.

### INDUSTRIAL APPLICABILITY

The ceramic thermal spray coating surface-treated by the present invention is widely applicable to various sliding members such as a bearing, a piston and a cylinder, having abrasion resistance improved by reduction of friction and adhesion. Further, the ceramic thermal spray coating surface-treated by the present invention has less fragile crushed layer which is likely to drop off after the smoothing treatment, and is thereby useful for an inner wall member of a plasma etching device for semiconductor production, which is required to have high cleanness.

### REFERENCE SYMBOLS

a: grinding mark, b: nascent surface, c: void

The entire disclosure of Japanese Patent Application No. 2022-059072 filed on Mar. 31, 2022 including specification, claims, drawings and summary is incorporated herein by reference in its entirety.

1. A surface treatment method for a ceramic thermal spray coating, which comprises jetting a slurry containing a liquid having a viscosity at a temperature of 20° C. of 10 mPa/s or lower and a powder medium having a polyhedral structure and having a median diameter (D50) of from 1 to 50 μm with a content of the powder medium of from 1 to 50 vol %, against a surface of a ceramic thermal spray coating, using a compressed gas under a pressure of from 0.01 to 1.0 MPa, to smooth the surface of the ceramic thermal spray coating.

2. The surface treatment method according to claim 1, wherein the ceramic thermal spray coating is formed of a rare earth oxide, a rare earth oxyfluoride, a rare earth fluoride, alumina (Al₂O₃), YAG(Y₃Al₅O₁₂) or YAP(YAlO₃).

3. The surface treatment method according to claim 1, wherein the powder medium is formed of tetrahedral or more polyhedral particles with an angle formed by faces of from 10 to 135°.

4. The surface treatment method according to claim 1, wherein the powder medium is formed of glass containing silicon oxide (SiO₂) as the main component, alumina (Al₂O₃), silicon carbide (SiC), boron carbide (B₄C), silicon nitride (Si₃N₄), zirconia (ZrO₂), carbon steel or stainless steel.

5. The surface treatment method according to claim 1, wherein the liquid is water or a C₂₋₄ alcohol.

6. The surface treatment method according to claim 1, wherein the compressed gas is air, nitrogen, carbon dioxide or argon.

7. The surface treatment method according to claim 1, wherein the surface of the ceramic thermal spray coating is smoothed to an arithmetic mean roughness Ra of 3.0 μm or less and a skewness Rsk of 0 or less.

8. The surface treatment method according to claim 1, wherein a plurality of grinding marks having a width of from 0.01 to 5 μm and a length of from 0.01 to 10 μm are formed on the surface of the ceramic thermal spray coating.

9. The surface treatment method according to claim 1, wherein the surface of the ceramic thermal spray coating is smoothed so that a nascent surface-occupied area ratio calculated by the following formula (1) is 10% or lower:
nascent surface-occupied area ratio (%)=(area of nascent surface/area of treated surface)×100 (1).

10. The surface treatment method according to claim 1, wherein the surface of the ceramic thermal spray coating is smoothed so that a grinding mark-occupied area ratio calculated by the following formula (2) is 50% or higher:
grinding mark-occupied area ratio (%)={(area of grinding mark region−area of voids−area of nascent surface)/area of treated surface}×100 (2).

11. The surface treatment method according to claim 1, wherein the ceramic thermal spray coating is a thermal spray coating on an inner wall member of a plasma etching device for semiconductor production.

12. The surface treatment method according to claim 1, wherein the ceramic thermal spray coating is a thermal spray coating on a sliding member selected from the group consisting of a bearing, a piston and a cylinder.

13. A ceramic thermal spray coating subjected to surface smoothing treatment, which has a treated surface having an arithmetic mean roughness Ra of 3 μm or less and a skewness Rsk of 0 or less.

14. The ceramic thermal spray coating according to claim 13, wherein a nascent surface-occupied area ratio calculated by the following formula (1) is 10% or less:
nascent surface-occupied area ratio (%)=(area of nascent surface/area of treated surface)×100 (1).

15. The ceramic thermal spray coating according to claim 13, wherein a grinding mark-occupied area ratio calculated by the following formula (2) is 50% or higher:
grinding mark-occupied area ratio (%)={(area of grinding mark region−area of voids−area of nascent surface)/area of treated surface}×100 (2).
